(19) United States
(12) Patent Application Publication
(10) Pub. No.: US 2007/0216046 A1
(43) Pub. Date: Sep. 20, 2007

(54) Manufacturing miniature structured elements with tool incorporating spacer elements

(75) Inventors: Hartmut Rudmann, Unterlunkhofen (CH); Stephan Heimgartner, Luzern (CH); Susanne Westenhofer, Wettswil (CH); Markus Rossi, Jona (CH)

Correspondence Address: RANKIN, HILL, PORTER & CLARK LLP, 4080 ERIE STREET, WILLOUGHBY, OH, 44094-7836, US

(73) Assignee: HEPTAGON OY, Espoo (FI)

(21) Appl. No.: 11/384,537

(22) Filed: Mar. 20, 2006

(51) Int. Cl. B29D 11/00

(52) U.S. Cl. 264/1.7; 425/174.4; 425/385

(57) ABSTRACT

A method of manufacturing a plurality of elements by replication includes the steps of: providing a replication tool that includes a plurality of replication sections having negative structural features defining the shape of the elements, the tool further including a plurality of first spacer portions; providing a substrate; moving the tool against the substrate, with a replication material in a plastically deformable or viscous or liquid state located between the tool and the substrate; hardening the replication material to form the elements, wherein the step of moving the tool against the substrate includes applying a predetermined force for moving the tool against the substrate, until the first spacer portions are located at a distance from the substrate, the distance being determined by the magnitude of the force, and with replication material remaining between the first spacer portions and the substrate.

### BACKGROUND OF THE INVENTION

1. Field of the Invention

The invention is in the field of manufacturing optical elements, in particular refractive optical elements and/or diffractive micro-optical elements, by means of a replication process that includes embossing or molding steps. More concretely, it deals with a method and a replication tool for manufacturing a plurality of elements as described in the preamble of the corresponding independent claims.

2. Description of Related Art

WO 2004/068198 by the same applicant, herewith incorporated by reference in its entirety, describes a replication process for creating micro-optical elements. A structured (or micro-structured) element is manufactured by replicating/shaping (molding or embossing or the like) a 3D structure in a preliminary product using a replication tool. The replication tool comprises a spacer portion protruding from a replication surface. A replicated micro-optical element is referred to as replica.

The spacer portions allow for an automated and accurate thickness control of the deformable material on the substrate. They may comprise “leg like” structures built into the tool. In addition, the spacers prevent the deformation of the micro optical topography since the spacers protrude further than the highest structural features on a tool.

The replica (for example a micro-optical element or micro-optical element component or an optical micro-system) may be made of epoxy, which is cured—for example UV cured—while the replication tool is still in place. UV light curing is a fast process that allows for a good control of the hardening process.

The replication process may be an embossing process, where the deformable or viscous or liquid component of the preliminary product to be shaped is placed on a surface of a substrate, which can have any size. For example, it can be small-size, having a surface area corresponding to the area of only one or a few elements to be fabricated. As an alternative, the substrate can be wafer scale in size. “Wafer scale” refers to the size of disk like or plate like substrates having sizes comparable to semiconductor wafers, such as disks having diameters between 2 inches and 12 inches. Then, the replication tool is pressed against this surface.

The embossing step stops once the spacer portions abut against the top surface of the substrate. The top surface, thus, serves as a stop face for the embossing.

As an alternative, the replication process may be a molding process. In a molding process, in contrast, the tool comprising the spacer portions, for example, comprising leg-like structures, is first pressed onto the surface of a substrate to form a defined cavity which is then filled through a molding process.

The spacer portion is preferably available in a manner such that it is “distributed” over at least an essential fraction of the replication tool, for example, over the entire replication tool or at the edge. This means that features of the spacer portion are present in an essential fraction of the replication tool, for example, the spacer portion consists of a plurality of spacers distributed over the replication surface of the replication tool. The spacers allow for an automated and accurate thickness control of the deformable material layer.

### BRIEF SUMMARY OF THE INVENTION

It is an object of the invention to create a method and a replication tool for manufacturing a plurality of elements of the type mentioned initially, which provides an improvement over the currently known tools and method.

According to a first aspect of the invention, a method of manufacturing a plurality of elements by replication including the steps of
providing a replication tool that comprises a plurality of replication sections having negative structural features defining the shape of the elements, the tool further including a plurality of first spacer portions with a flat surface portion;
providing a substrate;
moving the replication tool and the substrate against each other, with a replication material in a plastically deformable or viscous or liquid state located between the tool and the substrate;
applying a force for moving the tool and the substrate against each other, until the first spacer portions are located at a distance from the substrate, the flat surface portion parallel to a surface thereof, and with replication material remaining between the first spacer portions and the substrate, and
hardening the replication material to form the elements.

The first spacer portions may also be called “floating spacers” because the flat surface portions of the first spacer portions “float” over the substrate surface, separated from it by a thin layer of replication material.

The first spacer portions may be arranged so that the dicing lines—the lines where after replication, hardening and removing the replication tool, the substrate with hardened replication material is separated into individual parts, e.g. chips—are at the positions where first spacer portions were arranged. Therefore, along the dicing lines only a comparably thin layer of replication material, the base layer remains. This helps to prevent delamination of the replication material from the substrate.

The distance between the flat surface portion and the substrate, thus, the thickness of a layer of the replication material, may be determined by second spacer portions (“contact spacers”) which protrude higher on the replication tool than the first spacer portions and which abut upon the substrate surface during replication. As an alternative or in addition thereto, the distance may be determined by the balance between the magnitude of the force applied and the cohesive forces within the replication material, and, depending on the properties of the replication material possibly also adhesive forces between the replication material and the substrate and tool. As yet another alternative, the distance may determined by active distance adjusters and/or controllers (such as a mask aligner) or other means.

In this embodiment, the distance between the first spacer portions and the substrate is constrained by the relative height of the second spacer portions with respect to the first spacer portions. This provides even higher precision, with
the second spacer portions absorbing at least part of the force between the tool and substrate and determining a reference height of the first spacer portions with respect to the substrate, and
the first spacer portions—potentially being close to the element to be replicated—precisely defining local height differences. Also, the first spacer portions (via the replication material) may, if necessary, absorb a remainder of the force and settle at a predetermined distance from the substrate. The first spacer portions also allow the tool to adapt to minor irregularities of the planarity of the substrate.

For this purpose, the replication material is preferably applied to the tool or the substrate without covering a second spacer support area, such that no replication material is present between the second spacer portions and the substrate after the tool is moved against the substrate. That is, both the tool and the substrate have a second spacer support area. For the tool, this is the contact area of the tool itself, and for the substrate, it is the area on which the contact area of the tool will be placed.

Preferably, in the direction of movement of the tool against the substrate, the height of the first spacer portions and the height of the second spacer portions differ by a element spacer height difference, the element spacer height difference being in the range of 1 to 500, preferably 5 to 30, ideally 7-15 micrometers.

In a preferred embodiment of the invention, the first spacer portions and second spacer portions define a height of the elements above the substrate. This is possible since the final location of the tool over the substrate and, therefore, the height of the structured surface of the elements with respect to substrate is precisely controllable, as described. Preferably, the element is a refractive optical element and the height of the elements above the substrate is predetermined in accordance with required optical properties of the element. This feature is special for refractive elements, such as refractive lenses, where the relation or distance between the top and bottom surfaces plays a role, as opposed to diffractive elements, where the optical function is mainly defined by the function of the structured surface (a diffraction pattern) defined by the structure of the replication section.

The replication material may be dispensed in a single dispense operation (as a single blob) or as a few single dispenses, each providing replication material for a plurality of replication sections, on the substrate or on the replication tool for the entire tool-scale replication. If this is the case, the second spacer portions, if present, are preferably tool-scale spacer portions, for example, arranged at the periphery of the tool surrounding the replication sections. The second spacer portions then do not comprise or define any replication sections.

As an alternative, the replication material may be dispensed in an array of individual, separate dispense operations (or blobs). A potentially pre-determined volume of replication material is applied to an array of points, corresponding to the location of the parts to be separated later by dicing, and each blob of replication material for example being confined to a part. Each part comprises one element to be fabricated or a group of, for example, four elements and there are areas between the parts that are free of replication material. In this embodiment of the invention, the second spacer portions if present may be distributed over the entire replication tool. For example, each part may comprise a second spacer portion.

This alternative of dispensing replication material allows the provision of the replication sections with an optimal amount of replication material and reduces the chance of defects. Further details of this aspect are described in a co-pending application “Method and tool for manufacturing optical elements” by the same applicants and having the same filing day as the present application.

The element produced typically is a refractive or diffractive optical element, such as a lens, but also may have a micromechanical function in at least one region.

The tool comprises a plurality of replication sections, thus allowing for the simultaneous manufacturing of an array of elements on a common substrate. This common substrate may be part of an opto-electronic or micro-opto-electronic assembly comprising optical and electronic elements produced on a wafer scale and later diced into separate parts.

In an preferred embodiment of the invention, the step of applying said force is accomplished by giving the tool a predetermined weight and placing the tool above the substrate, or by giving the substrate a predetermined weight and placing the substrate above the tool, and letting gravity do the pressing. In this manner, the pressing force can be controlled very precisely and in a very simple manner. Even if no second spacers are present or, where peripheral second spacer portions are present, the stiffness of the replication tool is not sufficient to precisely locally define the z-dimension, the resulting distance between the first spacer portions and the substrate can be controlled very precisely and is reliably repeatable.

According to a further aspect of the invention, a replication tool for manufacturing a plurality of optical elements by replication from a replication material is provided, the replication tool comprising a plurality of replication sections having negative structural features defining the shape of the elements, the replication tool further comprising a plurality of first spacer portions with a flat surface portion and further comprises one or more second spacer portions for defining a distance between the tool and a substrate during replication, wherein the height of the second spacer portions, in a direction of movement of the replication tool against a substrate, is greater than the height of the first spacer portions.

In a preferred embodiment of the invention, each replication section has an associated first spacer portion surrounding it or being arranged around the replication section. The first spacer portion, thus, defines the shape or the boundary of a periphery of the element created by the replication section.

In a preferred embodiment of the invention, the total area covered by the first spacer portions is between 0.1% and 50%, preferably between 0.5% and 20%, especially preferred between 2% and 10% of the total area of the tool covering the substrate.

In a preferred embodiment of the invention, the total area covered by the second spacer portions, if present, is between 1% and 50%, preferably between 5% and 25%, especially preferred between 10% and 20% of the total area of the tool covering the substrate.

In a preferred embodiment of the invention, the total area covered by the (optional) second spacer portions is between 10% and 1000%, preferably between 25% and 400%, especially preferred between 50% and 200% of the total area covered by the first spacer portions.

Features of the method claims may be combined with features of the device claims and vice versa.

### BRIEF DESCRIPTION OF THE DRAWINGS

The subject matter of the invention will be explained in more detail in the following text with reference to preferred exemplary embodiments, which are illustrated in the attached drawings, which schematically show:

FIG. 1 a cross section through a replication tool;

FIG. 2 an elevated view of a replication tool;

FIG. 3 an elevated view of another replication tool;

FIGS. 4-6 steps of a replication process;

FIGS. 7-9 further tools and replication steps; and

FIG. 10 a flow diagram of replication process.

The reference symbols used in the drawings, and their meanings, are listed in summary form in the list of reference symbols. In principle, identical parts are provided with the same reference symbols in the figures.

### DETAILED DESCRIPTION OF PREFERRED EMBODIMENTS

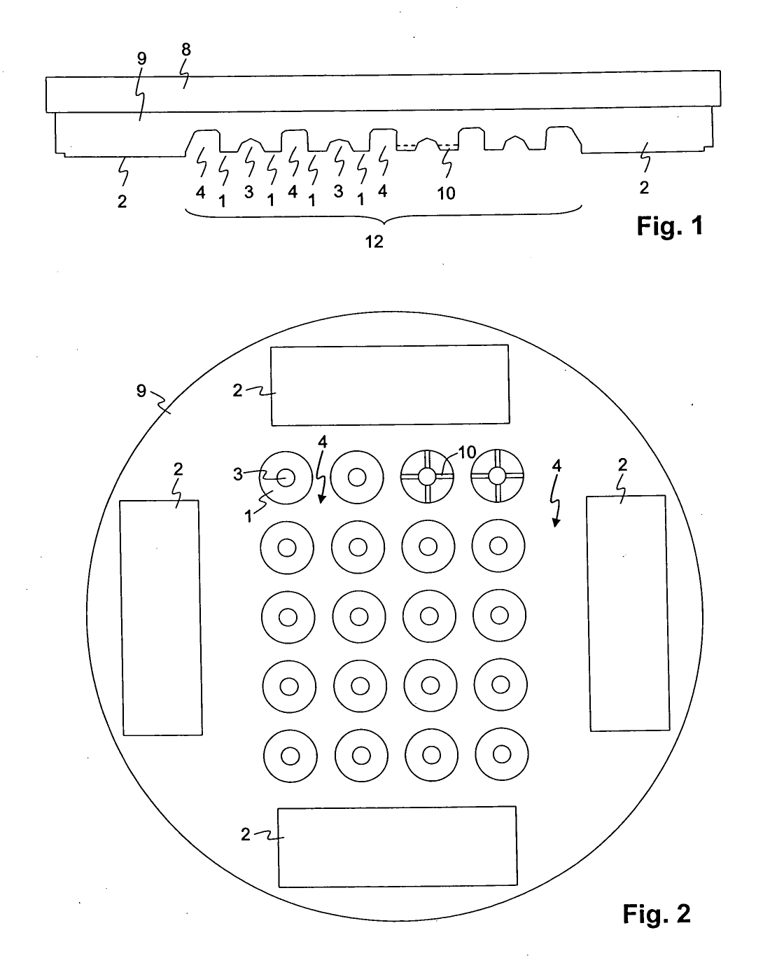

FIG. 1 schematically shows a cross section through a replication tool 9. The tool 9 comprises a plurality of replication sections 3, i.e. negative structural features defining the shape of elements 6 to be created with the tool 9. Each of the replication sections 3 is partially or completely surrounded at its periphery by a first spacer portion or local or element spacer portion 1. The area covered by the replication sections 3 and first spacer portions 1 interspersed in this manner is called the replication area 12. The replication tool may further comprise a rigid back plate 8 to make it dimensionally stiff on a large scale.

The first spacer portion 1 on the one hand serves to define the shape or the boundary of the element 6 in the region close to the substrate 7, and on the other hand to define the height of the element 6 with respect to a base layer. Depending on the dimensional stability of the replication tool 9, it may further serve for defining the height of the element 6 with respect to the substrate 7. That is, the first spacer portion 1 comes to rest against the substrate 7 or at a controllable distance from the substrate 7. The latter distance, the base layer thickness, also called “element spacer height difference”, here is determined by the vertical extension of the second spacer portions 2 relative to that of the first spacer portion 1.

In this text, for the sake of convenience, the dimension perpendicular to the surface of the substrate 7, which comprises an essentially flat surface is denoted as “height”. In actual practice, the entire arrangement may also be used in an upside down configuration or also in a configuration where the substrate surface is vertical or at an angle to the horizontal. The according direction perpendicular to the surface is denoted z-direction. The terms “periphery”, “lateral” and “sides” relate to a direction perpendicular to the z-direction. The terms “periphery” and “sides” of the element are thus understood when looking at the substrate from a direction perpendicular to the essentially flat substrate. The element covers a part of the substrate, and the surrounding other parts of the substrate, i.e. the region of space adjacent to both the substrate and the functional part of the element, in particular under the first spacer portions, may be covered with the replication material, without interfering with the function of the element.

The replication tool preferably is made of materials with some elasticity, for example, PDMS (polydimethylsiloxane) or another elastic material. This results in a conformal thickness control of the element 6 produced, even if the substrate surface on which the process is executed is not perfectly planar, or if the replication tool is not perfectly planar.

FIG. 2 shows an elevated view of a replication tool. Individual replication sections 3 are shown surrounded by first spacer portions 1. The first spacer portions 1 may each surround the replication section 3 in an unbroken circle, or may comprise spill or overflow channels 10 that make it easier for the replication material 5 to flow into areas or spill volumes (overflow volumes) 4. A number of separate second spacer portions 2 is arranged around the array of replication sections 3, at the periphery of the tool 9.

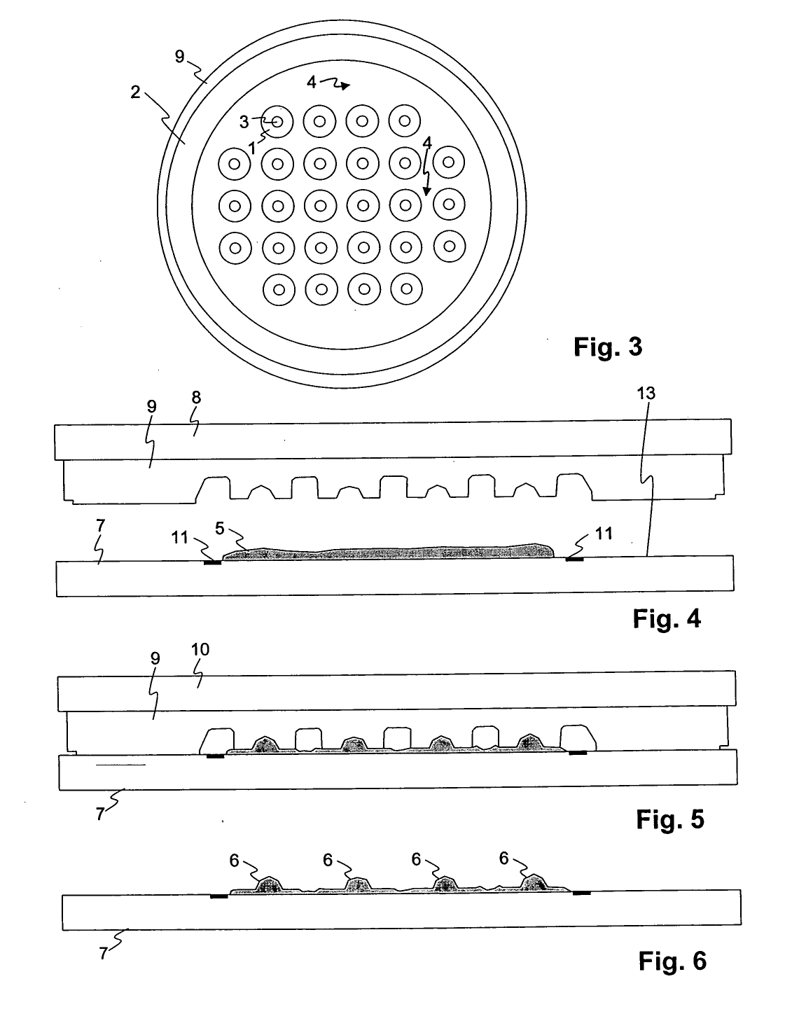

FIG. 3 shows an elevated view of another replication tool, in which a single second spacer portion 2 forms a ring around the grid of replication sections 3.

The tool 9 is preferably adapted to be used in wafer-scale processing, i.e. the substrate containing the array of replication sections may be disc-shaped. Thus, the diameter of the tool 9 preferably lies in a range from 5 cm to 30 cm. Wafer-scale combination of manufacturing with micro-electronics is possible, as is for example disclosed in WO 2005/083 789 by the same applicant, herewith incorporated by reference.

FIGS. 4-6 schematically show steps of a replication process involving a single dispense operation of replication material. In FIG. 4, the replication material 5 is applied to a substrate 7, and the tool 9 is positioned over the substrate 7. The second spacer portions 2 are positioned opposite corresponding second support areas 13 on the substrate 7. The replication material 5 such as an epoxy is in a plastically deformable or viscous or liquid state. Preferably, the replication material 5 is applied only to areas of the substrate 7 which will not come into contact with the second spacer portions 2, i.e. not to the second support areas 13. The same holds when the arrangement is operated in an inverted configuration, with the substrate 7 on top of the tool 9, and the replication material 5 applied to the tool 9. Guiding elements for controlling the relative horizontal displacement and/or the downward movement of the tool 9 may be present, but are not illustrated.

In a preferred embodiment of the invention, for the case in which the replication material 5 is applied to the substrate 7, the substrate 7 or the replication tool comprises a flow stopping section 11 with flow stopping means for preventing the replication material 5 from flowing onto the areas that are to come into contact with the second spacer portions 2. Flow stopping means on the substrate may be mechanical means such as ridges on, or troughs in, the substrate 7, or a mechanical or etching treatment that reduces the wetting capability of the substrate 7. Alternatively or in addition, such stopping means may be effected by using a different material for the flow stopping section 11 of the substrate 7, or applying a chemical to said section, to reduce the wetting property of the substrate 7. Flow stopping means on the replication tool may include discontinuities such as edges preventing the replication material to certain areas by way of capillary forces and/or surface tension. In addition or as an alternative to the flow stopping means of the substrate and/or the replication tool, the flow may also be confined by way of controlling the dynamics, i.e. by making sure the second spacer portions 2 abut the substrate before the replication material arrives at the second support areas.

In another preferred embodiment of the invention, the first spacer portions 1 do not surround every replication section 3, but are e.g. separate pillars dispersed over the replication area 12. In this manner, a certain area of the substrate 7 may remain covered with a thicker section of the replication material 5 that is not functional, as compared to the elements 6.

In FIG. 5, the tool 9 has been moved against the substrate 7. The force driving this movement is preferably only the gravity acting on the tool 9. Thus, the weight of the tool 9, including the back plate 8 and optionally an additional mass, defines the force with which the tool 9 is pressed against the substrate 7. This allows a very precise control of the force, and of any elastic deformation of the tool 9 that may take place. The replication sections 3 are filled with replication material 5, and also the spill volumes are at least partially filled by replication material 5.

The second spacer portions 2 touch the substrate 7 without any replication material 5 in between, such that most of the weight of the tool 9 rests on the second spacer portions 2. The first spacer portions 1 are separated from the substrate 7 by the element spacer height difference, the resulting volume being filled with replication material 5.

The ideal element spacer height difference is chosen according to geometrical and thermomechanical constraints. The height difference determines the thickness of a layer of replication material underneath the floating spacers, the so-called base layer. This thickness can either be given by the design of the element or by the specifications given due to thermomechanical properties. As an example, it may be required that the base layer thickness is below 15 μm to avoid delamination during the dicing process, as explained further below.

The replication material 5 is then hardened by thermal or UV or chemical curing.

In FIG. 6, the tool 9 has been removed from the substrate 7, leaving the hardened elements 6 on the substrate 7. Further processing depends on the nature and the function of the elements 6, i.e. the elements 6 may be separated from the substrate 7 or remain on the substrate 7 for further steps in a wafer-scale production process and later diced into separate parts.

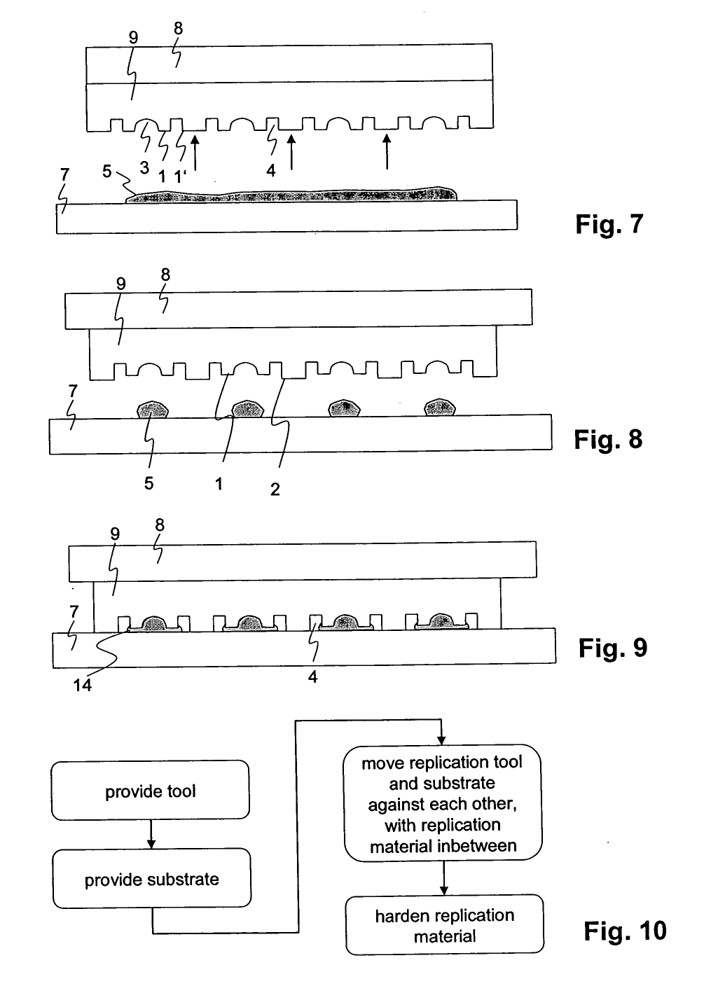

The replication tool 9 of FIG. 7 does not comprise any contact spacers. First spacer portions 1, 1′ surround the replication sections 3 but are also arranged between the parts which comprise at least one replication section. The region between the parts of the array is, for example, where after replication the dicing lines are chosen to lie. In FIG. 7, the corresponding locations on the tool are indicated by arrows. By way of the first spacer portions 1′ in the region between the parts only the thin base layer of replication material remains. This may be advantageous during the dicing process, where delaminating may occur for too thick layers of replication material. A method of manufacturing an optical element using a method that is particularly advantageous concerning the dicing process is described in an application “Manufacturing optical Elements” by Rudmann and Rossi filed on the same day as the present application, which is herein incorporated by reference.

The replication tool shown in FIG. 8 comprises first spacer portions 1 surrounding the replication sections and further comprises second spacer portions 2 distributed over the tool. Such a replication tool is particularly suited for “array replication” where the replication material is dispensed in an array like manner in a plurality of blobs to the points where the optical elements are to be created. In the shown example, the replication material 5 is dispensed on the substrate. It could also be dispensed to the tool, namely into the cavities which constitute the replication sections.

FIG. 9 shows the situation during replication, after the replication tool 9 and the substrate 7 have been moved against each other. During replication, the second spacer portions 2 abut the surface of the substrate, whereas there can be replication material underneath the first spacer portions 1, as illustrated in FIG. 9. Depending on the accuracy by which the replication material volume is determined, replication material may be displaced into the overflow volume 4 and for example form a bulge 14 along an outer edge of the first spacers.

FIG. 10 shows a flow diagram of the replication process.

While the invention has been described in present preferred embodiments of the invention, it is distinctly understood that the invention is not limited thereto, but may be otherwise variously embodied and practised within the scope of the claims.

1. A method of manufacturing a plurality of optical elements by replication, comprising the steps of:
providing a replication tool that comprises a plurality of replication sections having negative structural features defining the shape of the elements, the tool further comprising a plurality of first spacer portions with a flat surface portion;
providing a substrate;
moving the replication tool and the substrate against each other, with a replication material in a plastically deformable or viscous or liquid state located between the replication tool and the substrate;
applying a force for moving the replication tool and the substrate against each other, until the first spacer portions are located at a distance from the substrate, the flat surface portion parallel to a surface thereof, and with replication material remaining between the first spacer portions and the substrate, and
hardening the replication material to form the elements.

2. The method of claim 1, further comprising the step of determining said force by giving the replication tool a predetermined weight and placing the replication tool above the substrate, or by giving the substrate a predetermined weight and placing the substrate above the tool, and letting gravity do the pressing.

3. The method of claim 1, wherein the replication tool further comprises one or more second spacer portions with a flat surface portion, the second spacer portions for defining a distance between the replication tool and the substrate, and wherein the method step of moving the replication tool against the substrate comprises:
moving the replication tool against the substrate until the second spacer portions contact a surface of the substrate.

4. The method of claim 3, wherein the replication sections are interspersed with the first spacer portions, and wherein the second spacer portions are arranged at a periphery of the replication tool surrounding the replication sections and the second spacer portions do not comprise or define any replication sections.

5. The method of claim 3, further comprising the step of applying the replication material to the tool or the substrate without covering an area in a lateral position, which corresponds to the at least one second spacer portion such that no replication material is present between the second spacer portions and the substrate after the tool is moved against the substrate.

6. The method of claim 3, wherein the replication sections comprise first and second spacer portions.

7. The method of claim 3, wherein, in a direction of movement of the replication tool against the substrate, the height of the first spacer portions and the height of the second spacer portions differs by an element spacer height difference, the element spacer height difference being in the range of 5 micrometers to 30 micrometers.

8. The method of claim 1, wherein the first spacer portions define a height of the elements above the substrate.

9. The method of claim 8, wherein the element is a refractive optical lens.

10. The method of claim 1 wherein prior to moving the replication tool and the substrate against each other, the replication material is dispensed as a single contiguous amount of material or as a plurality of contiguous amounts of material each covering a plurality of said replication sections.

11. The method of claim 1, wherein prior to moving the replication tool and the substrate against each other, the replication material is dispensed in an array of amounts of material, each confined to a part containing one replication section.

12. The method of claim 1, wherein after hardening the replication material the replication tool is removed and sections of the substrate each carrying at least one of said elements, which are refractive lenses, are separated from each other along dicing lines, and wherein said dicing lines are along lateral positions of the substrate where during replication the first spacer portions were located.

13. A replication tool for manufacturing a plurality of optical elements by replication from a replication material, the replication tool comprising a plurality of replication sections having negative structural features defining the shape of the elements, the replication tool further comprising a plurality of first spacer portions with a flat surface portion and further comprises one or more second spacer portions for defining a distance between the replication tool and a substrate during replication, wherein the height of the second spacer portions, in a direction of movement of the replication tool against a substrate, is greater than the height of the first spacer portions.

14. The tool of claim 13, wherein, in a direction perpendicular to a main plane of the tool, the height of the first spacer portions and the height of the second spacer portions differs by an element spacer height difference, the element spacer height difference being in the range of 5 to 30 micrometers.

15. The replication tool of claim 13, wherein each first spacer portion is arranged around the associated replication section and defines the shape of a periphery of the element created by the replication section.

16. The replication tool of claim 13, wherein the total area covered by the first spacer portions is between 0.5% and 20% of the total area of the replication tool covering the substrate.

17. The replication tool of one of claim 13, wherein the total area covered by the second spacer portions is between 5% and 25% of the total area of the replication tool covering the substrate.

18. The replication tool of claim 13, wherein the replication sections are interspersed with the first spacer portions, and wherein the second spacer portions are arranged at a periphery of the replication tool surrounding the replication sections and the second spacer portions do not comprise or define any replication sections.

19. A method of manufacturing a plurality of optical elements, each comprising a refractive lens, by replication, comprising the steps of
providing a replication tool that comprises a plurality of replication sections having negative structural features defining the shape of the elements, each replication section comprising a dome-shaped portion and a protruding flat portion surrounding the dome-shaped portion, the flat portion serving as spacer and defining a height of the refractive lens,
providing a substrate;
moving the replication tool and the substrate against each other, with a replication material in a plastically deformable or viscous or liquid state located between the replication tool and the substrate;
hardening the replication material to form the elements;
removing the replication tool; and
separating parts of the substrate each carrying at least one of elements which is a refractive lens from each other.

20. The method of claim 19, wherein the step of moving the replication tool and the substrate against each other comprises applying a force for moving the tool and the substrate against each other, until the spacer is located at a distance from the substrate, the flat surface portion parallel to a surface thereof, and with replication material remaining between the first spacer portions and the substrate.

21. The method of claim 20, wherein the flat portion surrounding the dome-shaped portion is immediately adjacent the dome-shaped portion.

22. The method of claim 20, wherein said parts of the substrate are separated from each other along dicing lines, and wherein said dicing lines are along lateral positions of the substrate where during replication the spacer was located.

23. (canceled)
